(19) United States
(12) Patent Application Publication
(10) Pub. No.: US 2013/0195064 A1
(43) Pub. Date: Aug. 1, 2013

(54) METHOD AND APPARATUS FOR IMPROVING ACCURACY OF TRANSMITTING CSI VIA PUCCH

(71) Applicants: Hongwei Yang, PuDong Jinqiao Shanghai (CN); Lu Wu, PuDong Jinqiao Shanghai (CN); Hao Liu, PuDong Jinqiao Shanghai (CN)

(72) Inventors: Hongwei Yang, PuDong Jinqiao Shanghai (CN); Lu Wu, PuDong Jinqiao Shanghai (CN); Hao Liu, PuDong Jinqiao Shanghai (CN)

(73) Assignee: ALCATEL LUCENT, Paris (FR)

(21) Appl. No.: 13/877,625

(22) PCT Filed: Oct. 6, 2011
(86) PCT No.: PCT/IB2011/002827

§ 371 Date: Apr. 3, 2013

(30) Foreign Application Priority Data
Oct. 7, 2010 (CN) 201010503808.3

(51) Int. Cl. H04W 72/04

(52) U.S. Cl. CPC H04W 72/0413
USPC 370/329

(57) ABSTRACT

The present invention discloses a method and apparatus for improving the accuracy of transmitting CSI via PUCCH. The method for improving the accuracy of transmission of channel status information via the physical uplink control channel comprises reducing the number of bits of other channel information transmitted via the physical uplink control channel under the condition that the payload of the physical uplink control channel remains unchanged, and utilizing the thus-saved bits to transmit the channel state information to reduce the degree of sub-sampling the channel state information and thereby improve the accuracy of transmission of the channel status information via the physical uplink control channel. According to the present invention, system performance loss can be reduced.

### FIELD OF INVENTION

The present invention relates to the field of communication, and more particularly, to method and apparatus for improving the accuracy of transmitting CSI (channel state information) via PUCCH (physical uplink control channel).

### BACKGROUND OF THE INVENTION

In LTE R10, supporting 8 transmit antennas is an important feature to enhance peak data rate and system capacity. To efficiently facilitate single-user and multi-user precoding at an eNB, the channel state information (typically precoding matrix indicator, PMI) should be fed back by a UE to the eNB. It has been agreed in 3GPP RANI meeting that two-stage codebook will be used to quantize and feed back the CSI, wherein W1 (an index of code word in Codebook 1) targets for long-term CSI feedback, and W2 (an index of code word in Codebook 2) targets for short-term CSI feedback. One example of rank-1 and rank-2 codebooks for 8 transmit antennas can be found in [3GPP, RAN1-105011, Way Forward on 8Tx Codebook for Re1.10 DL MIMO] as the following:

$$B = [ \begin{matrix}{b}_{0} & {b}_{1} & … & {b}_{31}\end{matrix} ] , \\ {[ B ]}_{1 + m , 1 + n} = {e}^{j \frac{2 π mn}{32}} , \\ m = 0 , 1 , 2 , 3 , n = 0 , 1 , … , 31$$

$${X}^{( k )} ∈ \{ [ \begin{matrix}{b}_{2 kmod 32} & {b}_{( 2 k + 1 ) mod 32} & {b}_{( 2 k + 2 ) mod 32} & {b}_{( 2 k + 3 ) mod 32}\end{matrix} ] : k = 0 , 1 , … , 15 \}$$

$${W}_{1}^{( k )} = [ \begin{matrix}{X}^{( k )} & 0 \\ 0 & {X}^{( k )}\end{matrix} ]$$

Codebook 1: C₁={W₁⁽⁰⁾, W₁⁽¹⁾, W₁⁽²⁾, . . . , W₁⁽¹⁵⁾}

For rank 1

α₀1, α₁=j, α₂=−1, α₃=−j, eₖ is an 4×1 selection vector with all zeros except for the k-th element with value 1.

$${W}_{2}^{( 4 k + l )} = \frac{1}{\sqrt{2}} [ \begin{matrix}{e}_{k + 1} \\ {α}_{l} {e}_{k + 1}\end{matrix} ] , k = 0 , 1 , 2 , 3 ; l = 0 , 1 , 2 , 3$$

Codebook 2: C₂={W₂⁽⁰⁾, W₂⁽¹⁾, W₂⁽²⁾, . . . , W₂⁽¹⁵⁾}

For rank 2

α₀=1, α₁=j, eₖ is an 4×1 selection vector with all zeros except for the k-th element with value 1.

$$( {Y}_{1}^{0} , {Y}_{2}^{0} ) = ( {e}_{1} , {e}_{1} ) , \\ ( {Y}_{1}^{1} , {Y}_{2}^{1} ) = ( {e}_{2} , {e}_{2} ) , \\ ( {Y}_{1}^{2} {Y}_{2}^{2} ) = ( {e}_{3} , {e}_{3} ) , \\ ( {Y}_{1}^{3} , {Y}_{2}^{3} ) = ( {e}_{4} , {e}_{4} ) , \\ ( {Y}_{1}^{4} , {Y}_{2}^{4} ) = ( {e}_{1} , {e}_{2} ) , \\ ( {Y}_{1}^{5} {Y}_{2}^{5} ) = ( {e}_{2} , {e}_{3} ) , \\ ( {Y}_{1}^{6} , {Y}_{2}^{6} ) = ( {e}_{1} , {e}_{4} ) , \\ ( {Y}_{1}^{7} , {Y}_{2}^{7} ) = ( {e}_{2} , {e}_{4} )$$

$${W}_{2}^{( 2 k + l )} = \frac{1}{\sqrt{2}} [ \begin{matrix}{Y}_{1}^{k} & {Y}_{1}^{k} \\ {α}_{l} {Y}_{2}^{k} & - {α}_{l} {Y}_{2}^{k}\end{matrix} ] , \\ k = 0 , 1 , … , 7 ; l = 0 , 1$$

Codebook 2: C₂={W₂⁽⁰⁾, W₂⁽¹⁾, W₂⁽²⁾, . . . , W₂⁽¹⁵⁾}

It can be seen that the sizes of Codebook 1 and Codebook 2 for rank 1 and rank 2 are both 4 bits, i.e., each codebook includes 16 code words.

When PUCCH (physical uplink control channel) is used to convey the two-stage codebook as fast as possible instead of PUSCH (physical uplink shared channel), code words of Codebook 1 and Codebook 2 for rank 1 and rank 2 have to be sub-sampled in order to transmit them together with other mandatory channel information, wherein said other mandatory channel information includes at least 4 bits of CQI (channel quality indicator) and additional 3 bits of spatial differential CQI for a higher rank (the rank is larger than 1). The reason is that according to standards, the payload size of the PUCCH is 11 bits.

Sub-sampling the original 8 bits of W 1+W2 to 4 bits of the payload size of the PUCCH will cause serious system performance loss in some scenarios (for example, under the situation that linear antenna array is employed).

### SUMMARY OF THE INVENTION

Therefore, a solution is needed to reduce the system performance loss.

According to a first aspect of the present invention, there is a provided a method for improving the accuracy of transmission of channel status information via physical uplink control channel, comprising steps of:

reducing the number of bits of other channel information transmitted via the physical uplink control channel under the condition that the payload of the physical uplink control channel remains unchanged and utilizing the thus-saved bits to transmit the channel state information to reduce the degree of sub-sampling the channel state information and thereby improve the accuracy of transmission of the channel status information via the physical uplink control channel.

According to a second aspect of the present invention, there is a provided an apparatus for improving the accuracy of transmission of channel status information via physical uplink control channel, comprising:

transmitting means configured to reduce the number of bits of other channel information transmitted via the physical uplink control channel under the condition that the payload of the physical uplink control channel remains unchanged, and to utilize the thus-saved bits to transmit the channel state information to reduce the degree of sub-sampling the channel state information and thereby improve the accuracy of transmission of the channel status information via the physical uplink control channel.

Said other channel information comprises channel quality indicator and/or spatial differential channel quality indicator.

The channel state information comprises code words of Codebook 1 and Codebook 2.

### BRIEF DESCRIPTION OF THE ACCOMPANYING DRAWINGS

Other objects and effects of the present invention will become more apparent and comprehensible by way of the following description with reference to the drawings, wherein:

FIG. 1 illustrates an exemplary environment in which the present invention can be implemented;

FIG. 2 illustrates an apparatus for improving the accuracy of transmission of channel status information via the physical uplink control channel according to an embodiment of the present invention.

In all of the above figures, identical reference numerals denote identical, like or corresponding features or functions.

### DETAILED DESCRIPTION OF PREFERRED EMBODIMENTS

Specific embodiments according to the present invention are described with reference to the drawings.

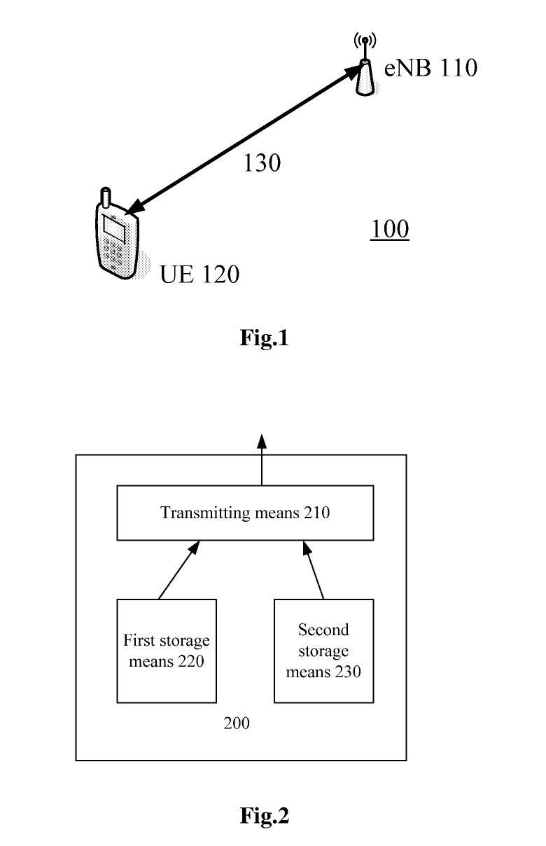

FIG. 1 illustrates an exemplary environment in which the present invention can be implemented.

As shown in FIG. 1, an environment 100 comprises an eNB 110 and a UE 120. Communication is carried out between the eNB 110 and the UE 120 via a wireless link 130, wherein the direction from the eNB 110 to the UE 120 is called downlink direction, and the direction from the UE 120 to the eNB 110 is called uplink direction.

The basic idea of the method for improving the accuracy of transmission of the channel status information via physical uplink control channel according to the present invention is to reduce the number of bits of other channel information transmitted via the physical uplink control channel under the condition that the payload of the physical uplink control channel remains unchanged, to utilize the thus-saved bits to transmit the channel state information to reduce the degree of sub-sampling the channel state information and thereby improve the accuracy of transmission of the channel status information via the physical uplink control channel.

More specifically, in an embodiment of the present invention, said other channel information comprises channel quality indicator and/or spatial differential channel quality indicator. The channel state information comprise code words of Codebook 1 and Codebook 2 (e.g., Codebook 1 and Codebook 2 for the rank 1 and rank 2; certainly, there can be Codebook 1 and Codebook 2 for a rank higher than 2 so long as the sum of the size of the corresponding Codebook 1 and Codebook 2 exceeds 4 bits). In the embodiment, under the condition that the overall payload size of the PUCCH is maintained to be 11 bits, the number of bits of the channel quality indicator and/or the spatial differential channel quality indicator is reduced from 4 bits/3 bits respectively, for example at least one bit is reduced, so that at least one bit is saved to transmit the code words of the Codebook 1 and the Codebook 2. Due to the accuracy of feedback of code words of the Codebook 1 and the Codebook 2 is improved, while the performance loss from sub-sampling CQI/spatial differential channel quality indicator could be small considering CQI itself is not accurate due to various system impairments and out-loop CQI control can reduce the impact caused by the sub-sampling, the system performance can be enhanced.

The present invention does not limit how to sub-sample the CQI/spatial differential channel quality indicator.

An example of sub-sampling the CQI/spatial differential channel quality indicator is described as below.

A 4-bit CQI table [page 50, table 7.2.3-1, 3GPP TS 36.213 V9.2.0, Physical layer procedures] (Table 1 as below) is uniformly sub-sampled to obtain Table 2.

TABLE 1

| CQI index | modulation | Code rate × 1024 | efficiency |
|---|---|---|---|
| 0 | Out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

TABLE 2

| CQI index | modulation | Code rate × 1024 | efficiency |
|---|---|---|---|
| 0 | Out of range | | |
| 1 | QPSK | 78 | 0.1523 |
| 2 | QPSK | 193 | 0.3770 |
| 3 | QPSK | 449 | 0.8770 |
| 4 | 16 QAM | 378 | 1.4766 |
| 5 | 16 QAM | 616 | 2.4063 |
| 6 | 64 QAM | 567 | 3.3223 |
| 7 | 64 QAM | 772 | 4.5234 |

Certainly, those skilled in the art can appreciate that Table 1 can be un-uniformly sub-sampled.

In addition, those skilled in the art can appreciate that Table 1 can even be sub-sampled to a larger extent so as to obtain less CQI.

Similarly, a 3-bit spatial differential channel quality indicator table [page 37, table 7.2.2, 3GPP TS 36.213 V9.2.0, Physical layer procedures] (Table 3 as below) is uniformly sub-sampled to obtain Table 4.

TABLE 3

| Spatial differential CQI value | Offset level |
|---|---|
| 0 | 0 |
| 1 | 1 |
| 2 | 2 |
| 3 | ≧3 |
| 4 | ≦−4 |
| 5 | −3 |
| 6 | −2 |
| 7 | −1 |

TABLE 4

| Spatial differential CQI value | Offset level |
|---|---|
| 0 | 0 |
| 1 | ≧3 |
| 2 | ≦−4 |
| 3 | −2 |

Certainly, those skilled in the art can appreciate that Table 3 can be un-uniformly sub-sampled.

In addition, those skilled in the art can appreciate that Table 3 can be even sub-sampled to a larger extent so as to obtain less spatial differential CQI.

Similarly, the present invention does not limit how to sub-sample the code words of Codebook 1 and Codebook 2.

An example of sub-sampling the code words of the Codebook 1 and the Codebook 2 is described as below. Code words wherein W1+W2 is equal to 5 bits are sub-sampled from the Codebook 1 and Codebook 2 in [3GPP, RAN1-105011, Way Forward on 8Tx Codebook for Re1.10 DL MIMO].
Codebook 1: C₁={W₁⁽⁰⁾, W₁⁽¹⁾, W₁⁽²⁾, . . . , W₁⁽¹⁵⁾}

Rank 1: Codebook2:

$${C}_{2} = \{ [ \begin{matrix}{e}_{1} \\ {e}_{1}\end{matrix} ] , [ \begin{matrix}{e}_{1} \\ - {e}_{1}\end{matrix} ] \}$$

That is to say, in this example, 16 (W1 is 4 bits) code words are taken from the Codebook 1, and two code words (W2 is 1 bit) are taken from the Codebook 2.

In the embodiment of the present invention, the method for improving the accuracy of transmission of the channel status information via the physical uplink control channel further comprises: storing a first table (Table 2 and/or Table 4) at the eNB 110 and the UE 120, the first table recording other channel information that should be transmitted via the physical uplink control channel after sub-sampling other channel information transmitted via the physical uplink control channel and thereby reducing the number of the bits of other channel information transmitted via the physical uplink control channel.

In the embodiment of the present invention, the method for improving the accuracy of transmission of the channel status information via the physical uplink control channel further comprises: storing a second table at the eNB 110 and the UE 120, the second table recording the channel state information that should be transmitted via the physical uplink control channel after sub-sampling the channel state information.

As such, after estimating the channel, the UE can determine the value of 5 bits of W1+W2 and value of CQI of 3 bits and value of spatial differential CQI of 3 bits by referring to the first table and the second table.

FIG. 2 illustrates an apparatus for improving the accuracy of transmission of channel status information via physical uplink control channel according to an embodiment of the present invention.

As shown in FIG. 2, an apparatus 200 comprises a transmitting means 210 configured to reduce the number of bits of other channel information transmitted via the physical uplink control channel under the condition that the payload of the physical uplink control channel remains unchanged, and to utilize the thus-saved bits to transmit the channel state information to reduce the degree of sub-sampling the channel state information and thereby improve the accuracy of transmission of the channel status information via the physical uplink control channel.

The apparatus 200 can further comprise a first storage means 220 configured to store a first table, the first table recording other channel information that should be transmitted via the physical uplink control channel after sub-sampling other channel information transmitted via the physical uplink control channel and thereby reducing the number of the bits of other channel information transmitted via the physical uplink control channel; a second storage means 230 configured to store a second table, the second table recording the channel state information that should be transmitted via the physical uplink control channel after sub-sampling the channel state information.

Said other channel information comprises channel quality indicator and/or spatial differential channel quality indicator.

The channel state information comprises code words of Codebook 1 and Codebook 2.

It should be noted that in order to make the present invention more comprehensible, the above description omits some more specific technical details which are known to the skilled in the art and may be essential to implement the present invention.

The purpose for providing the description of the present invention is to exemplarily explain and describe, not to exhaust or limit the present invention within the disclosed form. To those skilled in the art, various modifications and alternations are obvious.

Therefore, embodiments are selected and described in order to better construe principles of the present invention and actual application thereof and enable those having ordinary skill in the art to appreciate that all modifications and alterations without departure from the essence of the present invention fall within the protection scope of the present invention as defined by the appended claims.

In addition, those skilled in the art may readily appreciate that different steps of the above method may be performed by a programming computer. In this text, some embodiments are intended to cover program storage devices that may be machine or computer-readable and programmed with a machine-executable or computer-executable instruction program, wherein these instructions perform some or all of the steps of the above method. The program storage medium, for example, may be a magnetic storage medium (such as magnetic diskette or magnetic tape), a hard disk driver, or optical readable digital data storage medium. The embodiments are also intended to cover a computer programmed to execute steps of the above method.

1. A method for improving the accuracy of transmission of channel status information via physical uplink control channel, comprising stops of:
reducing the number of bits of other channel information transmitted via the physical uplink control channel under the condition that the payload of the physical uplink control channel remains unchanged, and utilizing the thus-saved bits to transmit the channel state information to reduce the degree of sub-sampling the channel state information and thereby improve the accuracy of transmission of the channel status information via the physical uplink control channel.

2. The method according to claim 1, further comprising:
storing a first table, the first table recording other channel information that should be transmitted via the physical uplink control channel after sub-sampling other channel information transmitted via the physical uplink control channel and thereby reducing the number of the bits of other channel information transmitted via the physical uplink control channel.

3. The method according to claim 1, further comprising:
storing a second table, the second table recording the channel state information that should be transmitted via the physical uplink control channel after sub-sampling the channel state information.

4. The method according to claim 1, wherein said other channel information comprises channel quality indicator and/or spatial differential channel quality indicator.

5. The method according to claim 1, wherein said channel state information comprises code words of Codebook 1 and Codebook 2.

6. An apparatus for improving the accuracy of transmission of channel status information via physical uplink control channel, comprising:
transmitting means configured to reduce the number of bits of other channel information transmitted via the physical uplink control channel under the condition that the payload of the physical uplink control channel remains unchanged, and to utilize the thus-saved bits to transmit the channel state information to reduce the degree of sub-sampling the channel state information and thereby improve the accuracy of transmission of the channel status information via the physical uplink control channel.

7. The apparatus according to claim 6, further comprising:
a first storage means configured to store a first table, the first table recording other channel information that should be transmitted via the physical uplink control channel after sub-sampling other channel information transmitted via the physical uplink control channel and thereby reducing the number of the bits of other channel information transmitted via the physical uplink control channel.

8. The apparatus according to claim 6, further comprising:
a second storage means configured to store a second table, the second table recording the channel state information that should be transmitted via the physical uplink control channel after sub-sampling the channel state information.

9. The apparatus according to claim 6, wherein said other channel information comprises channel quality indicator and/or spatial differential channel quality indicator.

10. The apparatus according to claim 6, wherein said channel state information comprises code words of Codebook 1 and Codebook 2.
